(19) United States
(12) Patent Application Publication
(10) Pub. No.: US 2026/0142890 A1
(43) Pub. Date: May 21, 2026

(54) METHOD AND SYSTEM FOR PROVIDING SESSION SPECIFIC TRANSMISSION OF DATA STREAMS USING AI

(71) Applicant: L&T TECHNOLOGY SERVICES LIMITED, Chennai (IN)

(72) Inventors: RAMALAKSHMI VENUGOPAL, Coimbatore (IN); DEEPIKA SUKUMAR GAJALAKSHMI, Coimbatore (IN)

(21) Appl. No.: 19/307,168

(22) Filed: Aug. 22, 2025

(30) Foreign Application Priority Data
Nov. 19, 2024 (IN) 202441089822

(51) Int. Cl. H04L 41/16; H04L 1/20

(52) U.S. Cl. CPC H04L 41/16; H04L 1/203

(57) ABSTRACT

The present disclosure relates to field of wireless communication that discloses method and system for providing session specific transmission of data streams using Artificial Intelligence (AI). System determines type of session initiated by source for transmission of data streams. System initiates encoding of data streams to obtain encoded data streams, using predefined modulation technique among modulation techniques that supports maximum number of bits. System transmits encoded data streams to source using antennas associated with transceiver system, and receives Bit Error Rate (BER) value and level value of cache memory of data streams from source. System determines based on level value in cache memory and BER value, updated modulation technique by comparing level value with level values in level table among level tables, using trained AI model. Finally, system transmits upcoming data stream using updated modulation technique. The present disclosure helps in providing session specific smooth transmission of data streams.

### TECHNICAL FIELD

The present disclosure relates to field of wireless communication. Particularly, the present disclosure relates to a method and system for providing session specific transmission of data streams using Artificial Intelligence (AI).

### BACKGROUND

Wireless communication is widely used for communication and transferring of media between two points without physical connection. With introduction of Long-Term Evolution (LTE) network and 5th Generation (5G), wireless communication is widely used and keeps on evolving due to recent developments in the field of wireless communication. In the existing system when a session is initiated by a User Equipment (UE) with a base station, the base station may transmit and receive data in a predefined manner. However, the existing system faces challenges in maintaining smooth data transmission, due to varying network conditions. As the varying network conditions may affect the quality of the connection, which leads to disruption in transmission or reception of data. Thus, there is a need to provide a system to provide smooth transmission of data.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a method of providing session specific transmission of data streams using Artificial Intelligence (AI). The method includes determining a type of session initiated by a source for transmission of a plurality of data streams. The type of session is determined based on a connection request received from the source. The method includes initiating encoding of the plurality of data streams to obtain a plurality of encoded data streams, using a predefined modulation technique among one or more modulation techniques, that supports maximum number of bits during modulation. Further, the method includes transmitting the plurality of encoded data streams to the source using one or more antennas associated with the transceiver system. The method includes receiving a Bit Error Rate (BER) value and a level value of a cache memory of the plurality of data streams from the source, upon transmitting the plurality of encoded data streams. Thereafter, the method includes determining based on the level value in the cache memory and the BER value, an updated modulation technique by comparing the level value with one or more level values in a level table among a plurality of level tables, using a trained AI model. The level table is related to the type of session. Finally, the method includes transmitting a plurality of upcoming data stream using the updated modulation technique.

Further, disclosed herein is a transceiver system for providing session specific transmission of data streams using Artificial Intelligence (AI) is disclosed. The transceiver system comprises a processor and a memory communicatively coupled to the processor, where the memory stores processor executable instructions, which, on execution, may cause the transceiver system to determine a type of session initiated by a source for transmission of a plurality of data streams. The type of session is determined based on a connection request received from the source. The transceiver system initiates encoding of the plurality of data streams to obtain a plurality of encoded data streams, using a predefined modulation technique among one or more modulation techniques, that supports maximum number of bits during modulation. The transceiver system transmits the plurality of encoded data streams to the source using one or more antennas associated with the transceiver system. Further, the transceiver system receives a Bit Error Rate (BER) value and a level value of a cache memory of the plurality of data streams from the source, upon transmitting the plurality of encoded data streams. Thereafter, the transceiver system determines based on the level value in the cache memory and the BER value, an updated modulation technique by comparing the level value with one or more level values in a level table among a plurality of level tables, using a trained AI model. The level table is related to the type of session. Finally, the transceiver system transmits a plurality of upcoming data stream using the updated modulation technique.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1A shows an exemplary architecture for communication between a transceiver system and a source for providing session specific transmission of data streams using Artificial Intelligence (AI), in accordance with some embodiments of the present disclosure;

FIG. 1B shows an exemplary illustration of transmission between a transceiver system and a source, in accordance with some embodiments of the present disclosure;

FIG. 1C shows an exemplary graph illustrating a change in probability of BER value with time using proposed transceiver system over the conventional technique, in accordance with some embodiments of the present disclosure;

FIG. 2 shows a detailed block diagram of the transceiver system for providing session specific transmission of data streams using Artificial Intelligence (AI), in accordance with some embodiments of the present disclosure;

FIG. 3 shows a flowchart illustrating method of providing session specific transmission of data streams using Artificial Intelligence (AI), in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

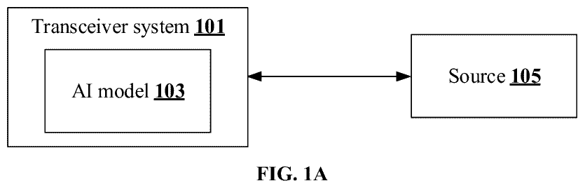

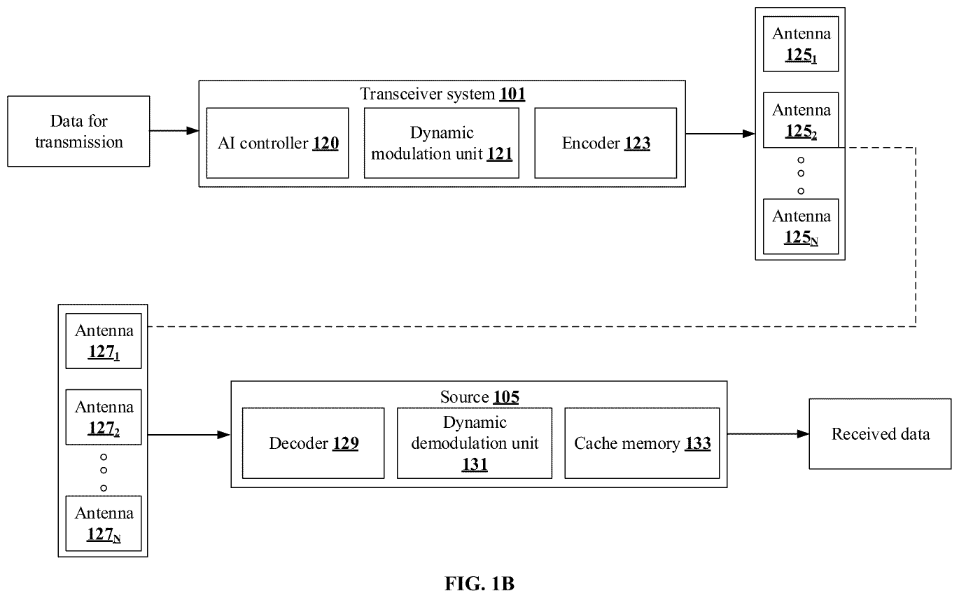

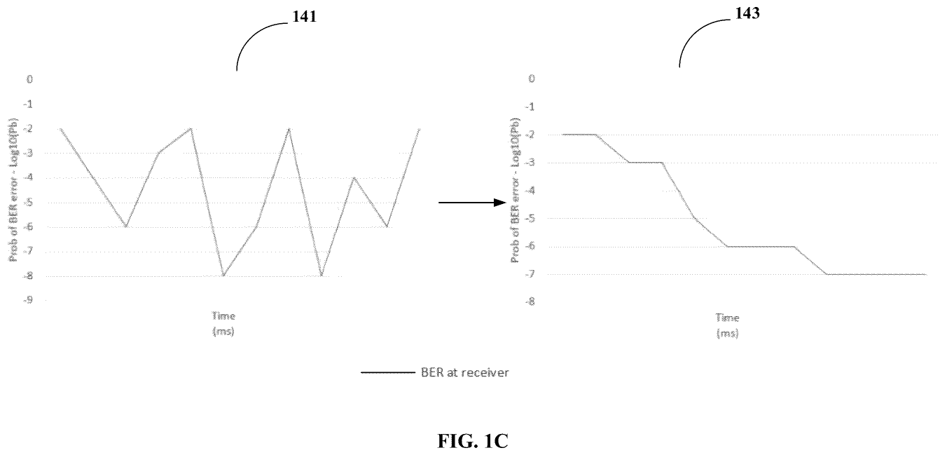

FIG. 1A shows an exemplary architecture for communication between a source and a transceiver system for providing session specific transmission of data streams using Artificial Intelligence (AI), in accordance with some embodiments of the present disclosure.

Exemplary architecture illustrates a transceiver system 101 associated with a source 105 through a communication network (not shown in figure). In an embodiment, the transceiver system 101 may represent an electronic device which may include a combination of transmitter and receiver for transmitting and receiving of signals. As an example, the signals may be wireless communication signals. In some embodiments, the transceiver system 101 may be associated with a base station through a communication network. The communication network may be a wired network and/or a wireless network. As an example, the base station may be, without limitation, macro cell, micro cell, pico cell, femto cell and Remote Radio Heads (RRH). In some embodiments, the transceiver system 101 may be associated with any type of access points. As an example, the access point may be, without limitation, Wireless Fidelity (WIFI), root access point, repeater access point, bridges, workgroup bridge and central unit in an all-wireless network. In some embodiments, the transceiver system 101 may be the base station. In an embodiment, the source 105 may transmit and receive data streams with the transceiver system 101 through the communication network. As an example, the source 105 may be a User Equipment (UE) which may include, without limitation, any device used by a user to communicate and/or access content such as, but not limited to, mobile phones, smartphones, laptops, wearables, Internet of Things (IoTs), and the like with LTE/5G/6G capabilities. As an example, the communication network may be a wireless telecommunication network such as Long-Term Evolution (LTE) network, 5th Generation (5G) network and the like.

In an embodiment, the transceiver system 101 may be configured to determine a type of session initiated by the source 105 for transmission of a plurality of data streams. The type of session may be determined based on a connection request received from the source 105. In an embodiment, the source 105 may indicate the type of session in the connection request. As an example, the source 105 may use a Session Initiation Protocol (SIP) to initiate connection with the transceiver system 101. The SIP may be used for initiating, maintaining, and terminating communication sessions, which may include voice, video, and messaging applications. As an example, the session may be, without limitation, voice calling session, video calling session, and messaging session.

In an embodiment, upon determining the type of the session, the transceiver system 101 may be configured to initiate encoding of the plurality of data streams using a predefined modulation technique among one or more modulation techniques. A skilled person may appreciate that there may be various modulation techniques available for encoding the data streams. For example, one or more modulation techniques may include, without limitation, Quadrature Amplitude Modulation (QAM), Phase-Shift Keying (PSK) and Binary Phase-Shift Keying (BPSK). As illustrated in FIG. 1B, encoder 123 may use plurality of encoding techniques to obtain a plurality of encoded data streams. In an embodiment, the transceiver system 101 may initiate the encoding of initial data streams using the predefined modulation technique which may support a maximum number of bits during modulation to obtain a plurality of encoded data streams. As an example, the predefined modulation technique may be selected as 1024 bit QAM. A skilled person may appreciate that there may be various modulation techniques which may support a maximum number of bits during modulation. In an embodiment, the predefined modulation technique which may support a maximum number of bits during modulation is selected to optimize high data throughput of the of the plurality of data streams which may be transmitted to the source 105.

In an embodiment, upon initiating the encoding of the plurality of data streams, the transceiver system 101 may be configured to transmit the plurality of encoded data streams to the source 105 using one or more antennas associated with the transceiver system 101. As illustrated in FIG. 1B, one or more antennas 125 associated with the transceiver system 101 may be used to transmit the plurality of encoded data streams. In an embodiment, the transceiver system 101 may be configured to transmit the plurality of encoded data streams with a time difference of a predefined duration. As an example, the predefined duration may be one millisecond. The transceiver system 101 may transmit the plurality of encoded data streams with a time difference of the predefined duration between transmissions to prevent collisions and ensure smoother delivery of data streams.

In an embodiment, upon transmitting the plurality of encoded data streams, the transceiver system 101 may be configured to receive a Bit Error Rate (BER) value and a level value of cache memory, upon transmitting the plurality of encoded data streams. The BER value may be a measure of quality of a digital communication channel. The BER value may represent the number of bits/data streams that are received incorrectly over the total number of bits/data streams transmitted. The level value of the cache memory may indicate the amount of data successfully buffered at the source 105. In an embodiment, the transceiver system 101 may receive the BER value and the level value periodically from the source 105. As illustrated in FIG. 1B, one or more antennas 125 associated with the transceiver system 101 may be used to receive the BER value and the level value.

In an embodiment, upon receiving the BER value and the level value of the cache memory, the transceiver system 101 may be configured to determine based on the level value in the cache memory and the BER value, an updated modulation technique by comparing the level value with one or more level values in a level table among a plurality of level tables, using a trained AI model 103. As an example, the trained AI model 103 may be, without limitation, machine learning AI Models, deep learning AI models, generative AI Models and hybrid AI models. The level table is related to the type of session. In an embodiment, the transceiver system 101 may determine whether the level value in the cache memory reaches a predefined first threshold. The predefined first threshold may ensure meeting a buffer data requirement for a quick initiation of a session. In other words, the predefined first threshold may allow the session to initiate even if the data quality is suboptimal, ensuring a faster start of the session. Also, the predefined first threshold ensures that there is enough buffered data to begin the session smoothly, preventing delays. Further, the transceiver system 101 may determine whether the BER value is more than a predefined BER threshold when the level value in the cache memory reaches the predefined first threshold. In an embodiment, the predefined BER threshold may be determined based on the session type, i.e., each type of session may have different predefined BER threshold as different sessions have different tolerance levels for errors. As an example, video calls require lower BER compared to file downloads. Upon determining that the cache memory reaches the predefined first threshold and the BER value is more than the predefined BER threshold, the transceiver system 101 may determine the updated modulation technique using a trained AI model 103. The AI model 103 may be trained using the plurality of level tables and the trained AI model 103 may be used to determine the updated modulation technique. The plurality of level tables may include, without limitation, the one or more level values and corresponding one or more modulation techniques. An example level table for voice call session is shown in Table A below:

TABLE A
Voice call session

| | |
|---|---|
| Cache Level | Modulation |
| Value | Technique |

| | | |
|---|---|---|
| <1400 | kbit | 1024 QAM |
| 2100 | kbit | 256 QAM |
| 2800 | kbit | 64 QAM |
| 3500 | kbit | 16 QAM |
| >4200 | kbit | BPSK |

In an embodiment, based on the level value received from the source 105, the trained AI model 103 may determine the updated modulation technique using the plurality of level tables. As an example, if the session is voice call and the level value of the cache memory is 2100 Kilobits (kbit), and the BER value is above the predefined BER threshold, the trained AI model 103 may be based on the BER and the level cache, determine the modulation technique that may be assigned for updation of the earlier modulation technique (1024 QAM). In particular, during the initial phase, 1024 QAM is assigned as the predefined modulation technique considering the maximum number of bits but the trained AI model 103 based on the real-time value of level value in the cache memory has updated/upgraded the modulation technique as 256 QAM. In an embodiment, when the level value of the cache memory is high, indicating that the cache memory is full, the trained AI model 103 may select the updated modulation technique which supports minimum number of bits among the one or more available modulation techniques. As an example, as shown in Table A, when the cache value is more than 4200 kbit, the trained AI model 103 may update the modulation technique as BPSK. Updating the modulation technique ensures that the transmission is optimized for current conditions, maintaining a balance between data rate and transmission quality. This also allows for real-time optimization based on the current session, catering to dynamic changes in transmission conditions.

In an embodiment, upon determining the updated modulation technique, the transceiver system 101 may be configured to transmit a plurality of upcoming data streams using the updated modulation technique. In an embodiment, the transceiver system 101 may receive a feedback from the source 105 upon transmitting the updated modulation technique. The feedback may include, without limitation, at least one of, the level value of the cache memory and the BER value. The feedback may be transmitted to the trained AI model 103. Further, the transceiver system 101, using the trained AI model 103, may keep on monitoring the real-time value of the level cache and the BER to further update the updated modulation technique. In other words, the transceiver system 101 may periodically update the modulation technique based on the level value of the cache memory and the BER value using the trained AI model 103 until the session is terminated. In an embodiment, the transceiver system 101 may dynamically update the plurality of level tables based on the feedback, using the trained AI model 103. This ongoing dynamic updating process ensures that the data transmission remains smooth and efficient, adapting to any changes in session requirements or transmission conditions. Also, the dynamic updating of modulation techniques helps in managing varying levels of network congestion, interference, and other real-time factors that could affect data transmission quality. In an exemplary embodiment, the transceiver system 101 using the trained AI model 103 may prioritize transmission data rate over the quality of the session according to type of the session. As an example, video streaming sessions might prioritize higher data rates with acceptable error levels to ensure smooth playback, voice calls might prioritize lower error rates to maintain clear audio quality, and online gaming might prioritize low latency and quick error correction to ensure responsive gameplay. In another embodiment, the transceiver system 101 using the trained AI model 103, may prioritize the quality of the session over the transmission data rate. As an example, in the regions where security is a concern, the quality of video streaming sessions might be prioritized over the transmission rate.

Referring to FIG. 1B, source may include, an AI controller 120, a decoder 129, a dynamic demodulation unit 131 and the cache memory 133. In an embodiment, the AI controller 120 may include, without limitation, the AI model 103 and plurality of level tables. The AI model 103 and the plurality of level tables may be dynamically updated based on the feedback. In an embodiment, once the encoded data streams are received from the transceiver system 101. The decoder 129 may decode the encoded data streams and the decoded data streams are demodulated using the dynamic demodulation unit 131, to obtain original information. In an embodiment, received data streams may be stored in the cache memory 133 and the level of the cache memory may be transmitted to the transceiver system 101 to dynamically update the modulation technique based on the level of the cache memory 133.

An example flow of the present disclosure is discussed. In an embodiment, when a voice session is initiated, SIP is a signaling protocol used to establish, manage, and terminate multimedia sessions. The transceiver system 101 may determine the type of session as voice session using the SIP. Further, the transceiver system 101 may initiate the encoding of the data with the modulation technique of 1024 QAM which supports maximum number of bits during modulation. Thereafter, the transceiver system 101 may receive the BER value and the level value of the cache memory from the source 105. As an example, till the level value reaches 1400 kbit the transceiver system 101 continues with the 1024 QAM modulation technique, and once the level value is more than 1400 kbit and lesser than 2100 kbit the transceiver system 101 continues with the 256 QAM, once the level value is more than 4200 kbit the transceiver system 101 continues with BPSK modulation. Also, while using the modulation of 1024 QAM the BER value is considered to start the session with more BER and then the BER value gradually reduces the BER after the session is started. As an example, the session may be started when the BER value is average as shown in below Table B, however BER will gradually increase with the change of modulation technique. Thus, the BER threshold is the “average error” shown in below Table B. The transceiver system 101 may dynamically update the modulation technique based on the BER value and the level value until the session is terminated. As illustrated in FIG. 1C, the graph 141 represents that data reception at the existing system, in which the data reception is irregular and the error value also varies, which causes challenges in the maintaining smooth data transmission. The graph 143 represent data reception when the data streams are transmitted using the transceiver system 101, according to the present disclosure. The transition in FIG. 1C, illustrates the transition in the BER value from the existing system to the transceiver system 101, according to the present disclosure. The data reception is regular and smooth as the dynamic updating of modulation techniques helps in managing varying levels of network congestion, interference, and other real-time factors that could affect data transmission quality. Also, the BER value remains constant which indicates that the quality of the transmission is maintained.

TABLE B

| BER value | Quality |
|---|---|
| <1E−05 | Bad |
| >1E−05 | Average |
| <1E−08 | Good |
| >1E−08 | Excellent |

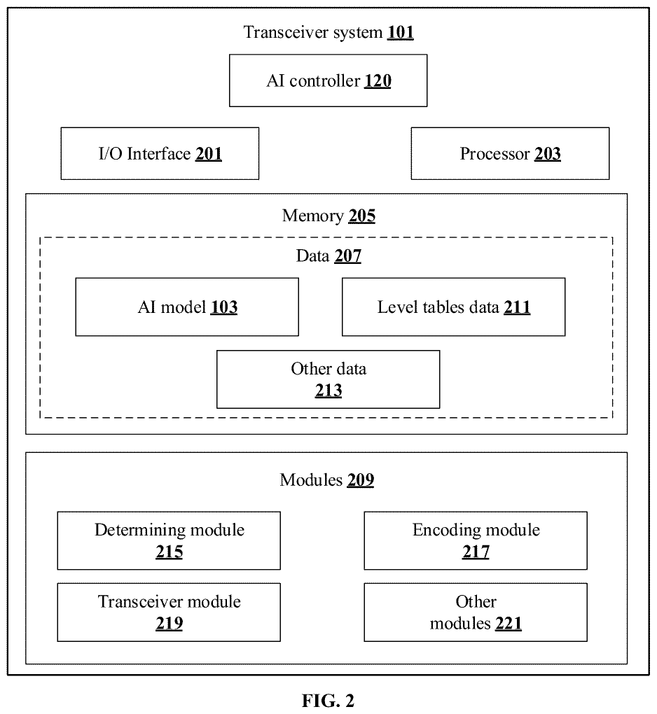

FIG. 2 shows a detailed block diagram of the transceiver system 101 for providing session specific transmission of data streams using Artificial Intelligence (AI), in accordance with some embodiments of the present disclosure.

In some implementations, the transceiver system 101 may include an I/O interface 201, a processor 203, a memory 205, and an AI controller 120. In an embodiment, the memory 205 may be communicatively coupled to the processor 203. The processor 203 may be configured to perform one or more functions of the transceiver system 101 for providing session specific transmission of data streams using Artificial Intelligence (AI), using the data 207 and the one or more modules 209 of the transceiver system 101. In an embodiment, the memory 205 may store the data 207.

In an embodiment, the data 207 stored in the memory 205 may include, without limitation, an AI model 103, level tables data 211 and other data 213. In some implementations, the data 207 may be stored within the memory 205 in the form of various data structures. Additionally, the data 207 may be organized using data models, such as relational or hierarchical data models. The other data 213 may include various temporary data and files generated by the one or more modules 209.

In an embodiment, the level tables data 211 may include level tables for each type of session. In some embodiment, the level tables data 211 may include plurality of level tables. In an embodiment, the plurality of level tables may include, without limitation, the one or more level values and corresponding one or more modulation techniques. The one or more level values may be cache level values. As an example, Table A above shows level table for voice call session. Similarly, Table C below shows level table for video call session.

TABLE C
Video call session

| | |
|---|---|
| Cache Level | Modulation |
| Value | Technique |

| | | |
|---|---|---|
| <2600 | kbit | 1024 QAM technique |
| 5200 | kbit | 1024 QAM |
| 7800 | kbit | 256 QAM |
| 10400 | kbit | 64 QAM |
| 13000 | kbit | 16 QAM |
| >14600 | kbit | BPSK |

In an embodiment, the data 207 may be processed by one or more modules 209 of the transceiver system 101. In some implementations, the one or more modules 209 may be communicatively coupled to the processor 203 for performing one or more functions of the transceiver system 101. In an implementation, the one or more modules 209 may include, without limiting to, a determining module 215, an encoding module 217, transceiver module 219 and other modules 221.

As used herein, the term module may refer to an Application Specific Integrated Circuit (ASIC), an electronic circuit, a hardware processor 203 (shared, dedicated, or group) and memory that execute one or more software or firmware programs, a combinational logic circuit, and/or other suitable components that provide the described functionality. In an implementation, each of the one or more modules 209 may be configured as stand-alone hardware computing units. In an embodiment, the other modules 221 may be used to perform various miscellaneous functionalities on the transceiver system 101. It will be appreciated that such one or more modules 209 may be represented as a single module or a combination of different modules.

In an embodiment, the determining module 215 may be configured to determine a type of session initiated by the source 105 for transmission of a plurality of data streams. The type of session is determined based on a connection request received from the source 105. As an example, the session may include, without limitation, voice calling session, video calling session, and messaging session.

In an embodiment, the encoding module 217 may be configured for initiating encoding of the plurality of data streams to obtain a plurality of encoded data streams, using a predefined modulation technique among one or more modulation techniques. The predefined modulation technique is the one that supports maximum number of bits during modulation. The one or more modulation techniques may include, without limitation, Quadrature Amplitude Modulation (QAM), Phase-Shift Keying (PSK) and Binary Phase-Shift Keying (BPSK). As an example, the predefined modulation technique may be 1024 bit QAM.

In an embodiment, the transceiver module 219 may be configured for transmitting the plurality of encoded data streams to the source 105 using one or more antennas associated with the transceiver system 101. In an embodiment, the transceiver module 219 may transmit the plurality of encoded data streams with a time difference of a predefined duration. As an example, the predefined duration may be one millisecond. The transceiver module 219 may transmit the plurality of encoded data streams with a time difference of the predefined duration between transmissions to prevent collisions and ensure smoother delivery of data streams.

In an embodiment, the transceiver module 219 may be configured for receiving a Bit Error Rate (BER) value and a level value of a cache memory of the plurality of data streams from the source 105, upon transmitting the plurality of encoded data streams. In an embodiment, the transceiver module 219 may receive the BER value and the level value periodically from the source 105.

In an embodiment, the determining module 215 may be configured for determining based on the level value in the cache memory and the BER value, an updated modulation technique by comparing the real-time level value with one or more level values present in a level table among a plurality of level tables, using a trained AI model 103. The level table is related to the type of session. In an embodiment, the level table is stored for video session whereas the other level table is stored for voice session. The determining module 215 may determine whether the level value in the cache memory reaches a predefined first threshold. The predefined first threshold may ensure meeting a buffer data requirement for a quick initiation of a session. In other words, the predefined first threshold may allow the session to initiate even if the data quality is suboptimal, ensuring a faster start of the session. Further, the determining module 215 may determine whether the BER value is more than a predefined BER threshold when the level value in the cache memory reaches the predefined first threshold. In an embodiment, the predefined BER threshold may be determined based on the session type, i.e., each type of session may have different predefined BER threshold as different sessions have different tolerance levels for errors. As an example, video calls require lower BER compared to file downloads. Upon determining that the cache memory reaches the predefined first threshold and the BER value is more than the predefined BER threshold, the determining module 215 may determine the updated modulation technique using the trained AI model 103. The AI model 103 may be trained using the plurality of level tables and the trained AI model 103 may be used to determine the updated modulation technique. In an embodiment, when the level value of the cache memory is high which indicates that the cache memory is full, the determining module 215 may select the updated modulation technique which supports minimum number of bits among the one or more modulation techniques. In some embodiment, the determining module 215 may be the AI controller 120, which may be configured to determine the updated modulation technique.

In an embodiment, the transceiver module 219 may be configured for transmitting a plurality of upcoming data stream using the updated modulation technique. In an embodiment, the transceiver module 219 may receive feedback from the source 105 upon transmitting the updated modulation technique. The feedback may include, without limitation, at least one of, the level value of the cache memory and the BER value. The feedback may be transmitted to the trained AI model 103. Further, the transceiver module 219 may dynamically update the updated modulation technique based on the feedback, using the trained AI model 103. In other words, the transceiver module 219 may periodically update the modulation technique based on the level value of the cache memory and the BER value using the trained AI model 103 until the session is terminated. In an embodiment, the transceiver module 219 may dynamically update the plurality of level tables based on the feedback, using the trained AI model 103.

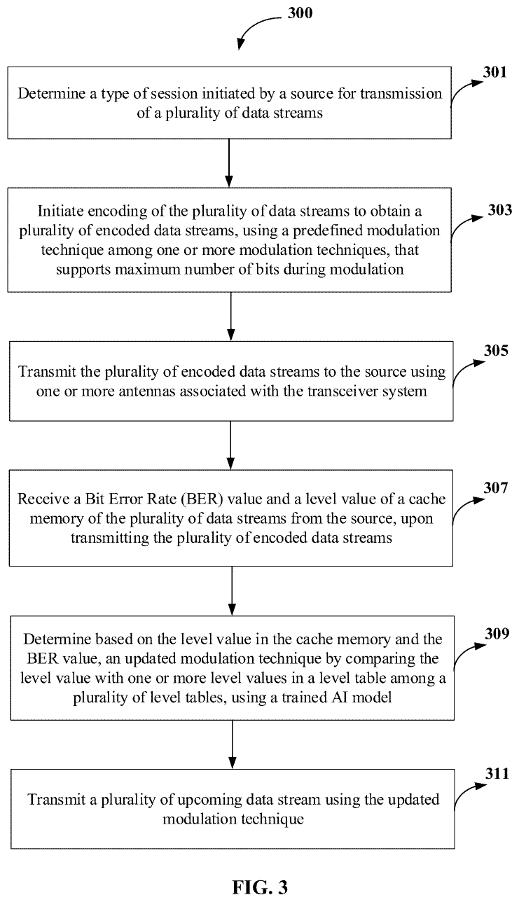

FIG. 3 is a flowchart illustrating a method of providing session specific transmission of data streams using Artificial Intelligence (AI) in accordance with some embodiments of the present disclosure.

As illustrated in FIG. 3, the method 300 may include one or more blocks illustrating a method of providing session specific transmission of data streams using Artificial Intelligence (AI) using the transceiver system 101 illustrated in FIG. 2. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the method 300 includes determining, by a processor 203 of the transceiver system 101, a type of session initiated by a source 105 for transmission of a plurality of data streams. The type of session is determined based on a connection request received from the source 105.

At block 303, the method 300 includes initiating, by the processor 203, encoding of the plurality of data streams to obtain a plurality of encoded data streams, using a predefined modulation technique among one or more modulation techniques, that supports a maximum number of bits during modulation.

At block 305, the method 300 includes transmitting, by the processor 203, the plurality of encoded data streams to the source 105 using one or more antennas associated with the transceiver system 101. In an embodiment, the processor 203 may transmit the plurality of encoded data streams with a time difference of a predefined duration.

At block 307, the method 300 includes receiving, by the processor 203, a Bit Error Rate (BER) value and a level value of a cache memory of the plurality of data streams from the source 105, upon transmitting the plurality of encoded data streams.

At block 309, the method 300 includes determining, by the processor 203, based on the level value in the cache memory and the BER value, an updated modulation technique by comparing the level value with one or more level values in a level table among a plurality of level tables, using a trained AI model 103. The level table is related to the type of session. In an embodiment, the processor 203 may determine whether the level value in the cache memory reaches a predefined first threshold. The predefined first threshold ensures meeting a buffer data requirement for a quick initiation of a session. Further, the processor 203 may determine whether the BER value is more than a predefined BER threshold when the level value in the cache memory reaches The predefined first threshold, the predefined BER threshold may vary based on the type of session. In an embodiment, the processor 203 may select the updated modulation technique which supports minimum number of bits among the one or more modulation techniques, when the level value of the cache memory is high which indicates that the cache memory is full. The plurality of level tables may include, without limitation, the one or more level values and corresponding one or more modulation techniques.

At block 311, the method 300 includes transmitting, by the processor 203, a plurality of upcoming data stream using the updated modulation technique. In an embodiment, the processor 203 may receive feedback from the source 105, wherein the feedback comprises at least one of, the level value of the cache memory and the BER value. The feedback is transmitted to the trained AI model 103. Further, the processor 203 may dynamically update the updated modulation technique based on the feedback, using the trained AI model 103. In an embodiment, the processor 203 may dynamically update the plurality of level tables based on the feedback, using the trained AI model 103.

### Computer System

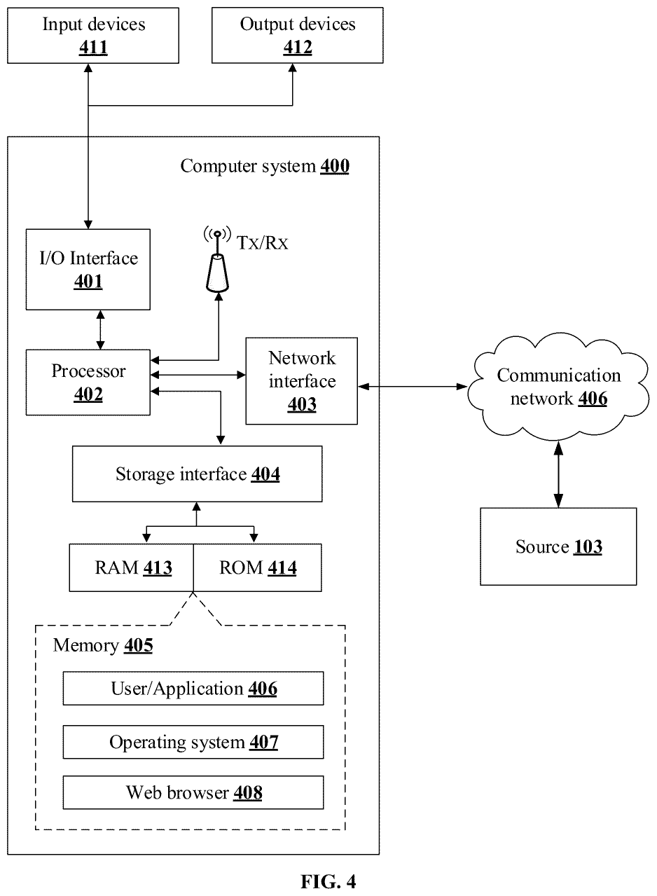

FIG. 4 illustrates a block diagram of an exemplary computer system 600 for implementing embodiments consistent with the present disclosure. In an embodiment, the computer system 400 may be transceiver system 101 illustrated in FIG. 1. The computer system 400 may include a central processing unit (“CPU” or “processor” or “memory controller”) 402. The processor 402 may comprise at least one data processor for executing program components for executing user- or system-generated business processes. A user may include a network manager, an application developer, a programmer, an organization, or any system/sub-system being operated parallelly to the computer system 400. The processor 402 may include specialized processing units such as integrated system (bus) controllers, memory controllers/memory management control units, floating point units, graphics processing units, digital signal processing units, etc.

The processor 402 may be disposed in communication with one or more Input/Output (I/O) devices (411 and 412) via I/O interface 401. The I/O interface 401 may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 401, the computer system 400 may communicate with one or more I/O devices 411 and 412.

In some embodiments, the processor 402 may be disposed in communication with a network 409 via a network interface 403. The network interface 403 may communicate with the network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc.

In an implementation, the preferred network 409 may be implemented as one of the several types of networks, such as intranet or Local Area Network (LAN) and such within the organization. The preferred network 409 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP) etc., to communicate with each other. Further, the network 409 may include a variety of network devices, including routers, bridges, transceiver systems, computing devices, storage devices, etc. Using the network interface 403 and the network 409, the computer system 400 may communicate with a source 105.

In some embodiments, the processor 402 may be disposed in communication with a memory 405 (e.g., RAM 413, ROM 414, etc. as shown in FIG. 6) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application interface 406, an operating system 407, a web browser 408, and the like. In some embodiments, computer system 400 may store user/application data 406, such as the data, variables, records, etc. as described in this invention. Such databases may be implemented as fault-tolerant, relational, scalable, secure databases such as Oracle® or Sybase®.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

The user interface 406 may facilitate display, execution, interaction, manipulation, or operation of program components through textual or graphical facilities. For example, the user interface 406 may provide computer interaction interface elements on a display system operatively connected to the computer system 400, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., Acro, Metro, etc.), web interface libraries (e.g., ActiveX®, JAVA®, JAVASCRIPT®, AJAX, HTML, ADOBE® FLASH®, etc.), or the like.

The web browser 408 may be a hypertext viewing application. Secure web browsing may be provided using Secure Hypertext Transport Protocol (HTTPS), Secure Sockets Layer (SSL), Transport Layer Security (TLS), and the like. The web browsers 408 may utilize facilities such as AJAX, DHTML, ADOBE® FLASH®, JAVASCRIPT®, JAVA®, Application Programming Interfaces (APIs), and the like. Further, the computer system 400 may implement a mail transceiver system stored program component. The mail transceiver system may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail transceiver system may utilize communication protocols such as Internet Message Access Protocol (IMAP), Messaging Application Programming Interface (MAPI), MICROSOFT®) exchange, Post Office Protocol (POP), Simple Mail Transfer Protocol (SMTP), or the like. In some embodiments, the computer system 400 may implement a mail client stored program component. The mail client may be a mail viewing application, such as APPLE® MAIL, MICROSOFT® ENTOURAGE®, MICROSOFT® OUTLOOK®, MOZILLA®) THUNDERBIRD®, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

In light of the technical advancements provided by the disclosed method, the claimed steps, as discussed above, are not routine, conventional, or not well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 101 | Transceiver system |
| 103 | Artificial Intelligence (AI) model |
| 105 | Source |
| 120 | AI controller |
| 121 | Dynamic modulation unit |
| 123 | Encoder |
| 125₁-125_{N} | One or more antennas of transceiver system |
| 127₁-127_{N} | One or more antennas of source |
| 129 | Decoder |
| 131 | Dynamic demodulation unit |
| 133 | Cache memory |
| 201 | I/O Interface |
| 203 | Processor |
| 205 | Memory |
| 207 | Data |
| 209 | Modules |
| 211 | Level tables data |
| 213 | Other data |
| 215 | Determining module |
| 217 | Encoding module |
| 219 | Transceiver module |
| 221 | Other modules |
| 400 | Computer system |
| 401 | I/O Interface of the exemplary computer system |
| 402 | Processor of the exemplary computer system |
| 403 | Network interface |
| 404 | Storage interface |
| 405 | Memory of the exemplary computer system |
| 406 | User/Application |
| 407 | Operating system |
| 408 | Web browser |
| 411 | Input devices |
| 412 | Output devices |
| 413 | RAM |
| 414 | ROM |

What is claimed is:

1. A method of providing session specific transmission of data streams using Artificial Intelligence (AI), the method comprising:
determining, by a transceiver system, a type of session initiated by a source for transmission of a plurality of data streams, wherein the type of session is determined based on a connection request received from the source;
initiating, by the transceiver system, encoding of the plurality of data streams to obtain a plurality of encoded data streams, using a predefined modulation technique among one or more modulation techniques, that supports maximum number of bits during modulation;
transmitting, by the transceiver system, the plurality of encoded data streams to the source using one or more antennas associated with the transceiver system;
receiving, by the transceiver system, a Bit Error Rate (BER) value and a level value of a cache memory of the plurality of data streams from the source, upon transmitting the plurality of encoded data streams;
determining, by the transceiver system, based on the level value in the cache memory and the BER value, an updated modulation technique by comparing the level value with one or more level values in a level table among a plurality of level tables, using a trained AI model, wherein the level table is related to the type of session;
transmitting, by the transceiver system, a plurality of upcoming data stream using the updated modulation technique.

2. The method of claim 1, wherein determining the updated modulation technique comprises:
determining, by the transceiver system, whether the level value in the cache memory reaches a predefined first threshold, wherein the predefined first threshold ensures meeting a buffer data requirement for a quick initiation of a session; and
determining, by the transceiver system, whether the BER value is more than a predefined BER threshold when the level value in the cache memory reaches the predefined first threshold, wherein the predefined BER threshold varies based on the type of session.

3. The method of claim 1, wherein transmitting the plurality of encoded data streams comprises transmitting the plurality of encoded data streams with a time difference of a predefined duration.

4. The method of claim 1, wherein determining the updated modulation technique comprises:
selecting the updated modulation technique which supports minimum number of bits among the one or more modulation techniques, when the level value of the cache memory is high which indicates that the cache memory is full.

5. The method of claim 1, wherein the plurality of level tables comprises the one or more level values and corresponding one or more modulation techniques.

6. The method of claim 1, further comprises:
receiving, by the transceiver system, a feedback from the source, wherein the feedback comprises at least one of, the level value of the cache memory and the BER value, wherein the feedback is transmitted to the trained AI model; and
dynamically updating, by the transceiver system, the updated modulation technique based on the feedback, using the trained AI model, wherein the plurality of level tables is dynamically updated based on the feedback, using the trained AI model.

7. A transceiver system for providing session specific transmission of data streams using Artificial Intelligence (AI), the transceiver system comprising:
a processor; and
a memory, communicatively coupled to the processor, wherein the memory stores processor executable instructions, which, on execution, causes the processor to:
determine a type of session initiated by a source for transmission of a plurality of data streams, wherein the type of session is determined based on a connection request received from the source;
initiate encoding of the plurality of data streams to obtain a plurality of encoded data streams, using a predefined modulation technique among one or more modulation techniques, that supports maximum number of bits during modulation;
transmit the plurality of encoded data streams to the source using one or more antennas associated with the transceiver system;
receive a Bit Error Rate (BER) value and a level value of a cache memory of the plurality of data streams from the source, upon transmitting the plurality of encoded data streams;
determine based on the level value in the cache memory and the BER value, an updated modulation technique by comparing the level value with one or more level values in a level table among a plurality of level tables, using a trained AI model, wherein the level table is related to the type of session;
transmit a plurality of upcoming data stream using the updated modulation technique.

8. The transceiver system of claim 7, wherein to determine the updated modulation technique, the processor is configured to:
determine whether the level value in the cache memory reaches a predefined first threshold, wherein the predefined first threshold ensures meeting a buffer data requirement for a quick initiation of a session;
determine whether the BER value is more than a predefined BER threshold when the level value in the cache memory reaches the predefined first threshold, wherein the predefined BER threshold varies based on the type of session.

9. The transceiver system of claim 7, wherein to determine the updated modulation technique, the processor is configured to:
select the updated modulation technique which supports minimum number of bits among the one or more modulation techniques, when the level value of the cache memory is high which indicates that the cache memory is full.

10. The transceiver system of claim 7, wherein the processor is further configured to:
receive a feedback from the source, wherein the feedback comprises at least one of, the level value of the cache memory and the BER value, wherein the feedback is transmitted to the trained AI model; and
dynamically update the updated modulation technique based on the feedback, using the trained AI model, wherein the processor is configured to dynamically update the plurality of level tables based on the feedback, using an AI model.

11. A non-transitory computer-readable medium storing computer-executable instructions for providing session specific transmission of data streams using Artificial Intelligence (AI), the computer-executable instructions configured for:
determining, by a transceiver system, a type of session initiated by a source for transmission of a plurality of data streams, wherein the type of session is determined based on a connection request received from the source;
initiating, by the transceiver system, encoding of the plurality of data streams to obtain a plurality of encoded data streams, using a predefined modulation technique among one or more modulation techniques, that supports maximum number of bits during modulation;
transmitting, by the transceiver system, the plurality of encoded data streams to the source using one or more antennas associated with the transceiver system;
receiving, by the transceiver system, a Bit Error Rate (BER) value and a level value of a cache memory of the plurality of data streams from the source, upon transmitting the plurality of encoded data streams;
determining, by the transceiver system, based on the level value in the cache memory and the BER value, an updated modulation technique by comparing the level value with one or more level values in a level table among a plurality of level tables, using a trained AI model, wherein the level table is related to the type of session; transmitting, by the transceiver system, a plurality of upcoming data stream using the updated modulation technique.

12. The non-transitory computer-readable medium of claim 1, wherein the computer-executable instructions are configured to determine the updated modulation technique by:
determining, by the transceiver system, whether the level value in the cache memory reaches a predefined first threshold, wherein the predefined first threshold ensures meeting a buffer data requirement for a quick initiation of a session; and
determining, by the transceiver system, whether the BER value is more than a predefined BER threshold when the level value in the cache memory reaches the predefined first threshold, wherein the predefined BER threshold varies based on the type of session.

13. The non-transitory computer-readable medium of claim 1, wherein transmitting the plurality of encoded data streams comprises transmitting the plurality of encoded data streams with a time difference of a predefined duration.

14. The non-transitory computer-readable medium of claim 1, wherein the computer-executable instructions are configured to determine the updated modulation technique by:
selecting the updated modulation technique which supports minimum number of bits among the one or more modulation techniques, when the level value of the cache memory is high which indicates that the cache memory is full.

15. The non-transitory computer-readable medium of claim 1, wherein the plurality of level tables comprises the one or more level values and corresponding one or more modulation techniques.

16. The non-transitory computer-readable medium of claim 1, wherein the computer-executable instructions are further configured for:
receiving, by the transceiver system, a feedback from the source, wherein the feedback comprises at least one of, the level value of the cache memory and the BER value, wherein the feedback is transmitted to the trained AI model; and
dynamically updating, by the transceiver system, the updated modulation technique based on the feedback, using the trained AI model, wherein the plurality of level tables is dynamically updated based on the feedback, using the trained AI model.
